(19) United States
(12) Patent Application Publication
(10) Pub. No.: US 2016/0190983 A1
(43) Pub. Date: Jun. 30, 2016

(54) Notification Apparatus Usable With Cooling System or Other System

(71) Applicant: EATON CORPORATION, CLEVELAND, OH (US)

(72) Inventors: Meng Wang, Eden Prairie, MN (US); Hassan Al-Atat, Lakeville, MN (US); Anirudh Reddy Edla, Kharadi (IN); Christopher Thompson, Menomonee Falls, WI (US)

(73) Assignee: EATON CORPORATION, CLEVELAND, OH (US)

(21) Appl. No.: 14/587,178

(22) Filed: Dec. 31, 2014

(51) Int. Cl. G01R 31/40; H02S 40/42

(52) U.S. Cl. CPC H02S 50/00; H02S 40/42

(57) ABSTRACT

A notification apparatus is usable with a cooling system of a solar inverter and employs various environmental and operational parameters to calculate a cooling efficiency of the cooling system. The value of the cooling efficiency is employed to determine the potential for cooling system problems. The notification apparatus may employ a software-based model of the cooling system that outputs a predicted cooling efficiency. If the difference between the actual cooling efficiency and the predicted cooling efficiency is within a predetermined tolerance, the notification apparatus can instruct the performance of a relatively less extensive diagnostic operation to be performed on the cooling system at night. If the difference in cooling efficiencies is outside the tolerance, a relatively more extensive diagnostic operation can be performed. A rule-based diagnostic system employs the coolant pressures at the inlet and outlet of a radiator to generate one or more diagnoses of the cooling system.

### BACKGROUND

1. Field

The disclosed and claimed concept relates generally to instrumentation and, more particularly, to a notification apparatus that is usable with a system such as a cooling system of a photovoltaic inverter.

2. Related Art

Solar panels include photovoltaic cells that generate DC power in the presence of visible light. It is known to convert such DC power into AC power through the use of an inverter that employs a number of Insulated-Gate Bipolar Transistor (IGBT) semiconductor devices or other semiconductor devices. As employed herein, the expression “a number of” and variations thereof shall refer broadly to any non-zero quantity, including a quantity of one. The inverter may be electrically connected with an electrical grid, and in such a situation the inverter detects the waveform of the AC power that is present in the grid and creates from the DC power an AC waveform that is synchronized with the grid waveform and that is output to the grid.

Since the IGBTs do the actual conversion between DC and AC, the IGBTs can themselves become hot. In order to avoid excessive heat damaging the IGBTs, utility-scale solar inverters typically employ a cooling system that includes a cooling circuit having a pump, a radiator, and some type of coolant that carries heat away from the IGBTs. It is also known, however, that such cooling systems typically are the single point of failure for a solar inverter and can cause system failures. While it may appear desirable to increase the number of sensing devices on a cooling system in order to monitor its operations, any such hardware change to an existing cooling system requires UL certification, and it increases cost. It is also noted that a cooling system failure will result in the solar system being non-operational during the cooling outage, which is highly undesirable. It thus would be desirable to provide improvements.

### SUMMARY

An improved notification apparatus that is usable with a system such as a cooling system of a solar inverter employs various environmental parameters and operational parameters to calculate a cooling efficiency of the cooling system, and the value of the cooling efficiency is employed to determine the potential for cooling system problems. The notification apparatus may employ a software-based model of the cooling system to which is input various environmental parameters and/or operational parameters and which outputs a predicted cooling efficiency. If the difference between the actual cooling efficiency and the predicted cooling efficiency is within a predetermined tolerance, the notification apparatus can instruct the perfoimance of a relatively less extensive diagnostic operation to be performed on the cooling system at night in order to detect the potential for other problems. If the difference in cooling efficiencies is outside the tolerance, a relatively more extensive diagnostic operation can be performed. In such a situation, the notification apparatus can additionally or alternatively employ a rule-based diagnostic system that employs the coolant pressures at the inlet and outlet of a radiator to generate one or more diagnoses of the cooling system.

Accordingly, an aspect of the disclosed and claimed concept is to provide an improved notification apparatus that is usable with a system such as a cooling system of a solar inverter.

Another aspect of the disclosed and claimed concept is to provide an improved notification apparatus that calculates the cooling efficiency of a cooling system to predict the potential for problems with the cooling system.

Another aspect of the disclosed and claimed concept is to provide an improved notification apparatus that utilizes a software-based model of a cooling system to generate a predicted cooling efficiency that can be used for comparison with an actual cooling efficiency to identify possible problems with the cooling system.

Another aspect of the disclosed and claimed concept is to provide a rule-based diagnostic routine that can employ the coolant pressures at the inlet and outlet of a radiator to generate a number of diagnoses of the cooling system.

Accordingly, an aspect of the disclosed and claimed concept is to provide an improved notification apparatus that is usable with an operable system, the system in operation having a number of operational parameters whose values vary and are based at least in part upon a number of environmental parameters whose values vary. The notification apparatus can be generally stated as including a processor apparatus comprising a processor and a storage, an input apparatus structured to provide input signals to the processor apparatus, an output apparatus structured to receive output signals from the processor apparatus, the storage having stored therein a number of routines that comprise a model which is representative of at least a portion of the system, the number of routines being executed on the processor causing the notification apparatus to perform various operations. The operations can be generally stated as including receiving an input comprising a value of at least a first environmental parameter of the number of environmental parameters, subjecting the input to at least a portion of the number of routines to generate a number of predicted values for at least some of the number of operational parameters, calculating a predicted operational efficiency value of the system that is based at least in part on at least some of the number of predicted values, receiving another input comprising a number of actual values for at least some of the number of operational parameters, calculating an actual operational efficiency value of the system that is based at least in part on at least a portion of the another input, and making a comparison between a pre-established tolerance value and a difference between the predicted operational efficiency value and the actual operational efficiency value.

Another aspect of the disclosed and claimed concept is to provide an improved notification apparatus that is usable with an operable system, the system in operation having a number of operational parameters whose values vary. The notification apparatus can be generally stated as including a processor apparatus comprising a processor and a storage, an input apparatus structured to provide input signals to the processor apparatus, an output apparatus structured to receive output signals from the processor apparatus, the storage having stored therein a number of routines that include a rule-based diagnostic routine which, when executed on the processor, causes the notification apparatus to perform various operations. The operations can be generally stated as including receiving an input comprising a number of values for at least some of the number of operational parameters, inputting at least a portion the input to the rule-based diagnostic routine which has a number of rules wherein a particular diagnosis results from at least one value from among the number of values being of a predetermined magnitude, and outputting from the rule-based diagnostic routine at least a first diagnosis that is based at least in part upon the at least portion of at least one of the number of predicted values and the number of actual values.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved notification apparatus in accordance with the disclosed and claimed concept;

FIG. 2 is a schematic depiction of a cooling system of a solar inverter with which the notification apparatus of FIG. 1 is advantageously employed;

FIG. 3 is a schematic depiction of a software-based model of the cooling system operating in parallel with the physical cooling system in order to determine a difference between an actual cooling efficiency of the cooling system and a predicted cooling efficiency of the cooling system;

FIG. 4 is a flowchart depicting certain aspects of the operation of the notification apparatus of FIG. 1;

FIG. 5 is a flowchart depicting other aspects of the operation of the notification apparatus of FIG. 1; and

FIG. 6 is a table depicting a number of rules of a rule-based diagnostic routine of the notification apparatus of FIG. 1.

Similar numerals refer to similar parts throughout the specification.

### DESCRIPTION

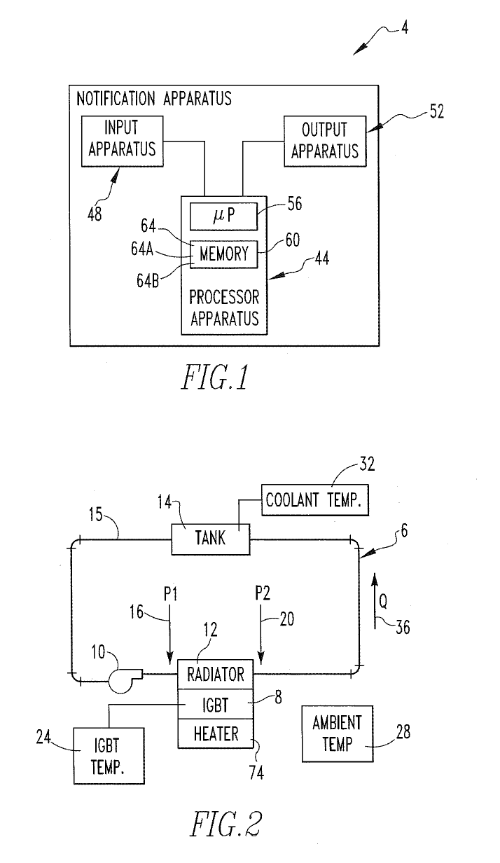

An improved notification apparatus 4 in accordance with the disclosed and claimed concept is depicted in a schematic fashion in FIG. 1. The notification apparatus 4 is usable with a system that can operated in some fashion, such as a cooling system 6 of a solar inverter. The solar inverter is represented by an IGBT 8 that is schematically depicted in FIG. 2.

The cooling system 6 is depicted herein in an exemplary fashion as comprising a pump 10, a radiator 12, and a tank 14 that are connected together via a cooling circuit 15 in the form of pipes or other flow channels that extend therebetween. The radiator 12 is depicted in FIG. 2 as being in physical contact with the IGBT 8 in order to remove heat from the IGBT 8 by transferring the heat to a coolant that travels through the cooling circuit 15. At an inlet to the radiator 12, an inlet pressure 16 of the coolant can be detected, such as through the use of an appropriate sensor. The inlet pressure 16 may be referred to elsewhere herein with the designation P1. At an outlet of the radiator 12, an outlet pressure 20 of the coolant can be detected, such as through the use of an appropriate sensor. The outlet pressure 20 may be referred to elsewhere herein with the designation P2. An IGBT temperature 24 can be detected with an appropriate temperature sensor, and an ambient temperature 28 can likewise be detected with an appropriate temperature sensor. A coolant temperature 32 can be detected with the use of an appropriate temperature sensor, and the exemplary coolant temperature 32 is depicted herein as being measured within the tank 14, although the coolant temperature at other locations within the cooling circuit 15 can be employed without departing from the present concept. During operation of the cooling system 6, the coolant flowing through the cooling circuit 15 has a flow rate 36 that can be measured directly if a flow rate sensor is provided in the cooling system. Alternatively, the flow rate 36 can be derived from the various operational parameters of the pump 10. The flow rate 36 may be referred to elsewhere herein with the designation Q.

The inlet and outlet pressures 16 and 20, and the IGBT temperature 24, the ambient temperature 28, and the coolant temperature 32 are depicted herein as being parameters that are in existence, rather than depicting the various sensors that might be used to obtain such parameters. This is because the particular method of obtaining or otherwise deriving the values of the parameters is not necessarily critical to the operation of the notification apparatus 4. Rather, it is emphasized that the inlet and outlet pressures 16 and 20, the coolant temperature 32, and the flow rate 36 are operational parameters of the cooling system 6 whose values vary during operation of the cooling system 6 and which may be provided as inputs to the notification apparatus 4. Likewise, the IGBT temperature 24 and the ambient temperature 28 are environmental parameters whose values vary with environmental conditions and other conditions during operation of the cooling system 6, and it is understood that such environmental parameters can likewise be input to the notification apparatus 4.

As can be seen in a schematic system in FIG. 1, the notification apparatus 4 can be said to include a processor apparatus 44, an input apparatus 48, and an output apparatus 32. The processor apparatus 44 can be said to include a processor 56 and a memory 60, with the memory 60 having stored therein a set of routines that are indicated generally at the numeral 64. The routines 64 more particularly include a software-based model 64A that is representative of the cooling system 6 and further include a rule-based diagnostic routine 64B that can diagnose problems with the cooling system 6 based upon merely the inlet and outlet pressures 16 and 20.

The processor 56 can be any of a wide variety of processors such as microprocessors and the like without limitation, and the memory 60 is a non-transitory storage medium that may include any one or more of RAM, ROM, EPROM, FLASH, and the like without limitation. The routines 64 that are stored in the memory 60 include instructions that are executed by the processor 56 to cause the notification apparatus 4 to perform certain operations that will be set forth in greater detail below.

The input apparatus 48 provides input signals to the processor apparatus 44 and can be said to include, for instance, inputs for any one or more of the inlet and outlet pressures 16 and 20, the IGBT temperature 24, the ambient temperature 28, and the coolant temperature 32, as well as the flow rate 36, an inverter power 68, and a pump parameter 72, by way of example. The input apparatus 48 can have inputs for other parameters. The inverter power 68 is an environmental parameter and represents the amount of AC power that is being output by the IGBT 8 at any given time, which is based upon the amount of sunlight that is impinging on the solar panels and upon other factors. The pump parameter 72 is an operational parameter and may actually be a plurality of parameters such as the efficiency of the pump 10, the speed of the pump 10, the electrical current that is being provided to the pump 10, and the like without limitation. The pump parameter 72 can be employed to derive the flow rate 36 and is usable for other purposes. The input apparatus 48 can further include other known types of input devices such as keyboards, card readers, and the like without limitation.

The output apparatus 52 receives output signals from the processor apparatus 44 and can be said to include any of a variety of output devices such as computer display screens, printers, visible or audible warning devices such as flashing lights and sirens, respectively, and other output devices. Another output device of the output apparatus 52 is a heater 74 which, when operated in a fashion that will be set forth in greater detail below, is operable to heat the IGBT 8 in a predetermined fashion during a diagnostic procedure that is performed on the cooling system 6.

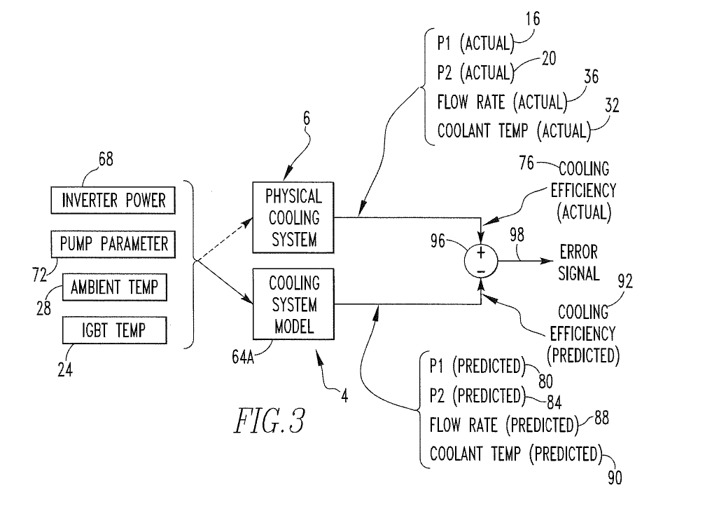

As can be understood from FIG. 3, the notification apparatus 4 may employ the model 64A effectively simultaneously or in parallel with operation of the cooling system 6 in order to identify possible shortcomings with the cooling system 6. FIG. 3 depicts the inverter power 68, the pump parameter 72, the ambient temperature 28, and the IGBT temperature 24 as being exemplary parameters whose values vary during operation of the cooling system 6 and which serve as exemplary inputs to the model 64A. FIG. 3 depicts with a solid arrow these parameters being actual inputs to the model 64A, whereas a dashed line FIG. 3 represents the fact that these same parameters affect various aspects of the cooling system 6. It is also noted that these four parameters are examples of parameters that can be input to the model 64A, it being understood that a greater or lesser number of parameters and/or other parameters may be employed depending upon the needs of the particular application. For instance, if the cooling system 6 happens to have a flow rate sensor that can directly measure the flow rate 36, the flow rate 36 can be used as an input to the model 64A in place of the pump parameter 72. Furthermore, entirely different parameters may be employed if the notification apparatus 4 is configured for use with a system other than a cooling system of a solar inverter. It is understood that the teachings presented herein regarding the notification apparatus 4 can be implemented and conjunction with virtually any type of operable system without departing from the present concept.

In accordance with an aspect of the disclosed and claimed concept, the operation of the cooling system 6 to cool the IGBT 8 results in a set of operational parameters such as the inlet and outlet pressures 16 and 20, the flow rate 36, and the coolant temperature 32, by way of example. The values of these parameters are each the actual value of the parameter that is measured either directly or indirectly or is derived from other data. From these various actual parameter values, an actual cooling efficiency 76 can be calculated by the processor apparatus 44. The cooling efficiency 76 is an operational efficiency value of the cooling system 6 and can be determined in any of a variety of fashions involving all or fewer than all of the environmental and operational parameters set forth herein. Numerous exemplary formulas for calculating the cooling efficiency 76 are known to exist.

The cooling efficiency 76 is a better indicator of a possible problem with the cooling system 6 than, for instance, the various operational parameters set forth above since the cooling efficiency 76 is a more comprehensive property of the cooling system 6 and relates to actual cooling performance rather than a parameter. The cooling efficiency 76 value is better able to indicate potential problems with the cooling system 6 than the various individual operational parameters are capable of providing. Depending upon the particular implementation, the actual cooling efficiency 76 in other embodiments can be compared with a benchmark cooling efficiency, and an alert to a potential problem or other action can be initiated if the actual cooling efficiency 76 departs too far from the benchmark. By way of further example, the cooling efficiency 76 can be monitored and an alert generated if the cooling efficiency 76 varies in an unnatural fashion in view of its history.

Advantageously, however, the exemplary notification apparatus 4 presented herein employs the model 64A to generate, for instance, a predicted inlet pressure 80, a predicted outlet pressure 84, a predicted flow rate 88, and a predicted coolant temperature 90, although it is reiterated that these are merely examples of some of the types of predicted operational parameters than can be generated by the model 64A. It is emphasized that additional parameters, other parameters, etc. can be generated by the model 64A based upon the needs of the particular application.

The notification apparatus 4 then calculates a predicted cooling efficiency 92 based upon predicted parameters and/or other parameters such as the predicted inlet and outlet pressures 80 and 84, the predicted flow rate 88, and the predicted coolant temperature 90. It is emphasized, however, that fewer and/or other parameters may be employed to calculate the predicted operational efficiency of the cooling system 6. The predicted cooling efficiency 92 of the cooling system 6 is the cooling efficiency that would be expected to be obtained from the cooling system 6, if it is assumed that the model 64A is reliable and the various components of the cooling system 6 are performing in the expected fashion. If the model 64A is reliable, i.e., accurately reflects the cooling system 6, the predicted cooling efficiency 92 should be close to the actual cooling efficiency 76.

The actual cooling efficiency 76 and the predicted cooling efficiency 92 are thus applied to a comparator 96 that calculates the difference between the actual and predicted cooling efficiencies 76 and 92 and determines whether the difference is within a predetermined tolerance. If the tolerance is not exceeded, the cooling system 6 is preliminarily considered to be healthy and normal, and further operations such as some of the diagnostic operations that are set forth in greater below can be performed to convert the preliminary indication of health of the cooling system 6 into a more conclusive indication of health.

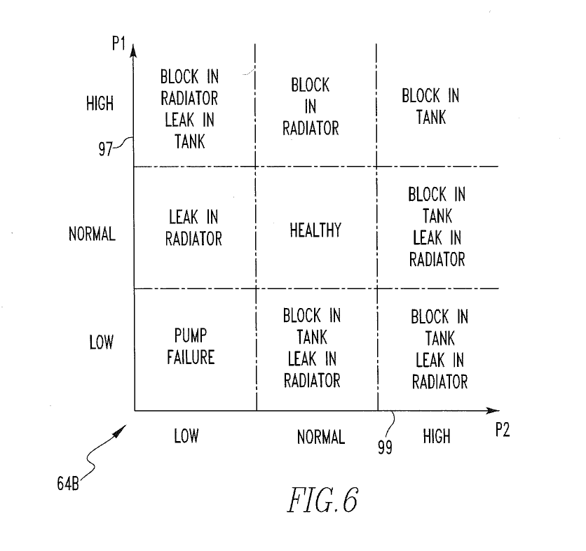

If the difference between the actual and predicted cooling efficiencies 76 and 92 exceeds the threshold, an error signal 98 can be generated that can be in any of a variety of forms. The error signal 98 might be employed to cause the output apparatus 52 to output on a visual display a notification to the effect that the cooling system 6 may have a potential problem and that care should be used with continued operation of the cooling system 6. Alternatively, the rule-based diagnostic routine 64B might be employed to identify and output one or more possible diagnoses of the potential problem with the cooling system 6, such as will be set forth in greater detail below and as is shown in FIG. 6. It is emphasized, however, that the actual output by the output apparatus 52 can be any type of output that is appropriate to the circumstances of the particular application and can be dependent upon other factors such as the magnitude of the difference between the actual and predicted cooling efficiencies 76 and 92 or based upon other data or information.

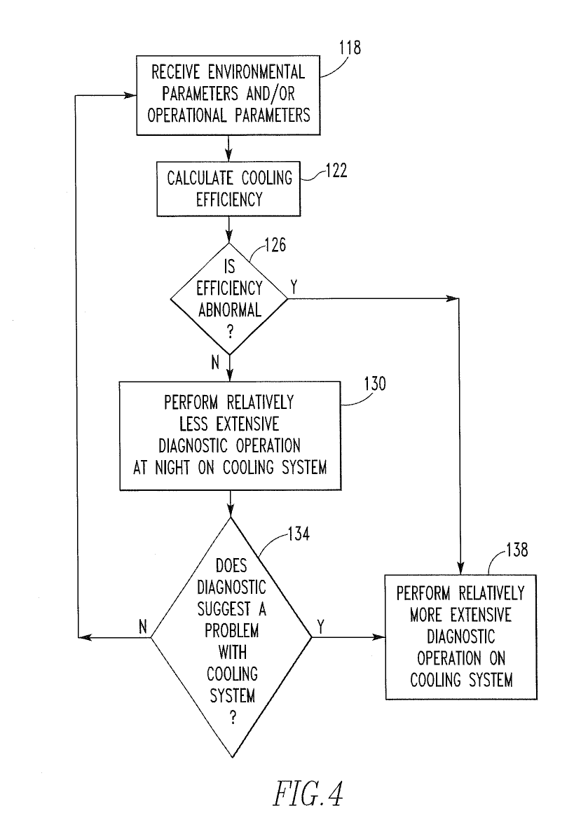

Certain operations of the notification apparatus 4 and/or the cooling system 6 are depicted in the flowchart of FIG. 4. Certain environmental parameters and/or operational parameters are received, as at 118, and are used to calculate, as at 122 a cooling efficiency. This could be the actual cooling efficiency 76 or additionally could include the predicted cooling efficiency 92. It is then determined, as at 126, whether the cooling efficiency 76 is abnormal. This could be determined by comparing the actual and predicted cooling efficiencies 76 and 92 or could be based upon a comparison of the actual cooling efficiency 76 with benchmarks or other relevant data.

If it is determined at 126 that the cooling efficiency 76 is not abnormal, processing continues, as at 130, where the notification apparatus 4 can optionally instruct the performance at night of a relatively non-extensive diagnostic operation on the cooling system 6. In this regard, the actual cooling efficiency 76 that is calculated at 122 is based upon variable environmental factors such as the IGBT temperature 24, the ambient temperature 28, the inverter power 68, and other such parameters that may be incapable of control by a technician. These parameters may result in a cooling efficiency value 76 that does not indicate the existence of abnormal cooling because the particular environmental parameters were not of sufficient magnitude to identify problems with the cooling system 6.

However, since the IGBT 8 is non-operational during the nighttime, a nighttime diagnostic operation may involve energizing the heater 40 and the pump 10 in order to determine an actual cooling efficiency 76 during the diagnostic procedure. In such a situation, the heat from the heater 40 can either be at a fixed value or can vary with time such as in a sinusoidal fashion, a ramp fashion, a step fashion, etc. Such a diagnostic operation can put a greater load on the various components of the cooling system 6 and can identify potential problems based upon, for instance, an actual cooling efficiency 76 that occurs during the diagnostic operation and a predicted cooling efficiency 92 that is predicted for the diagnostic operation, etc. The diagnostic operation permit greater predetermined stresses to be placed on the cooling system 6, such as would help to identify potential problems with the cooling system 6.

Also, the conducting of such diagnostic procedures on a regular basis, say once every night, enables the cooling efficiency 76 on any night to be compared with the cooling efficiency 76 on any other night to identify whether an abnormal change in the cooling efficiency 76 is occurring. In this regard, the comparison of a daytime cooling efficiency with another daytime cooling efficiency may not be especially availing since one day might be sunny and hot whereas another day may have been sunny and cold and yet another day may have been partly cloudy and cold. The daytime cooling efficiencies 76 potentially may not be meaningfully combinable or comparable with one another because of the widely divergent environmental parameters that may be in existence on any given day. However, by providing a predetermined heat input with the heater 40, which can be predicted night after night, the cooling efficiency 76 values during the nighttime diagnostic operation can be more meaningfully compared with one another to identify potential problems with the cooling system 6.

If it is determined, as at 134, that the nighttime diagnostic has not identified any problem with the cooling system, processing can continue, as at 118. However, if abnormal cooling efficiency is detected either at 126 during daytime normal operations or at 134 during nighttime diagnostic operations, a relatively more extensive diagnostic operation can be performed on the cooling system 6. The relatively more extensive diagnostic operation instructed at 138 may be performed immediately upon such instruction or it may be delayed until nighttime depending upon the needs of the particular application. The relatively more extensive diagnostic operation performed at 138 may include the inputting of the actual inlet and outlet pressures 16 and 20 and/or the predicted inlet and outlet pressures 80 and 84 to the rule-based diagnostic routine 64B for further processing.

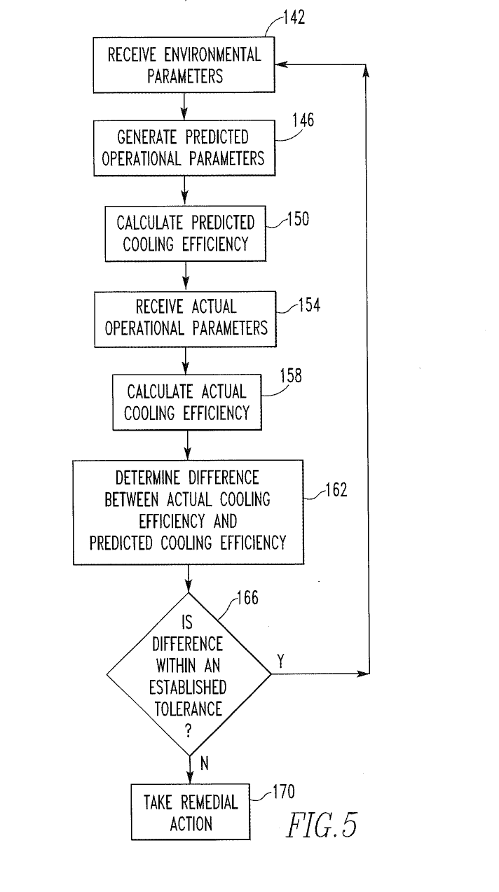

The assessment of cooling efficiency that is indicated at 126 and elsewhere in FIG. 4 is described in greater detail in the flowchart of FIG. 5. One or more environmental parameters are received by the input apparatus 48, as at 142, and the model 64A is then employed, as at 146, to generate one or more predicted operational parameters. The predicted operational parameters that are generated at 146 may include the predicted operational parameters set forth above and/or may include other parameters. A predicted cooling efficiency 92 is then calculated, as at 150, by the processor apparatus 44.

Another advantage of the use of the model 64A is to be able to generate, as at 146, predicted operational parameters that are continuously variable. For instance, the actual operational parameters such as the inlet and outlet pressures 16 and 20, the coolant temperature 32, and the flow rate 36 can only be directly measured in the fashion that is permitted by, for instance, the sensor that provides such a measured value. Such a sensor might not provide, for example, a rate of change over time of the operational parameter. Additional software and/or logic may be required to convert a series of absolute parameter values into a time-varying rate of change value or an equation. It is noted, however, that the predicted operational parameters that are generated by the model 64A at 146 are each advantageously continuously variable and can therefore be mathematically and logically manipulated by the processor apparatus 44 in a fashion that would be difficult to accomplish with a series of actual values of operational parameters. The model 64A thus enables more robust data analysis depending upon the needs of the particular application.

A series of actual operational parameters are then received, as at 154, by the input apparatus 48, and an actual cooling efficiency 76 is calculated, as at 158, based upon the received operational parameters and/or other parameters and/or other values. A difference between the actual cooling efficiency 76 and the predicted cooling efficiency 92 is then determined, as at 162. It is then determined, as at 166, whether the difference determined at 162 is within a pre-established tolerance. If the difference is within the tolerance, processing continues, as at 142. However, if the difference between the actual and predicted cooling efficiencies 76 and 92 is outside the pre-established tolerance, remedial action may be taken, as at 170. The remedial action 170 may include the relatively more extensive diagnostic operation that is indicated at 138 in FIG. 4 and/or may include other remedial action.

FIG. 6 depicts an exemplary set of rules for the rule-based diagnostic routine 64B and includes a P1 axis 97 that indicates a pressure range for the inlet pressure 16 between “low” and “high”, and further includes a P2 axis 99 that depicts a similar range of values for the outlet pressure 20. If the inlet and outlet pressure values 16 and 20 are each “normal”, the diagnosis from the rule-based diagnostic routine 64B is “healthy”. On the other hand, if the inlet pressure 16 is “high” and the outlet pressure 20 is “low”, the diagnosis is either a block in the radiator 12 or a leak in the tank 14 or both. FIG. 6 depicts in a limited fashion some of the rules that can be employed by the rule-based diagnostic routine 64B. It thus is understood that other rules can be employed depending upon the needs of the particular application. It is emphasized that the rule-based diagnostic routine 64B outputs its diagnoses based solely upon the inlet pressure 16 and the outlet pressure 20, and it is understood that the inlet and outlet pressure values 16 and 20 are readily available in any configuration of the cooling system 6. That is, any particular embodiment of the cooling system 6 may or may not include a flow rate sensor and may or may not include other sensors. However, the cooling system 6 will generally always include a pair of sensors that detect the inlet pressure 16 and the outlet pressure 20, which means that the rule-based diagnostic routine 64B can be employed in conjunction with virtually any implementation of the cooling system 6. The model 6 and the rules-based diagnostic routine 64B can each also be used individually or in combination within the scope of the present concept. The use of either the model 64A and the rule-based diagnostic routine 64B can yield advantages by identifying a possible problem for attention prior to a catastrophic failure of the cooling system 6, which is desirable. However, the combination of the two routines 64A and 64B provides even more enhanced prediction capabilities, which is even more desirable.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof

What is claimed is:

1. A notification apparatus usable with an operable system, the system in operation having a number of operational parameters whose values vary and are based at least in part upon a number of environmental parameters whose values vary, the notification apparatus comprising:
a processor apparatus comprising a processor and a storage;
an input apparatus structured to provide input signals to the processor apparatus;
an output apparatus structured to receive output signals from the processor apparatus;
the storage having stored therein a number of routines that comprise a model which is representative of at least a portion of the system, the number of routines being executed on the processor causing the notification apparatus to perform operations comprising:
receiving an input comprising a value of at least a first environmental parameter of the number of environmental parameters;
subjecting the input to at least a portion of the number of routines to generate a number of predicted values for at least some of the number of operational parameters;
calculating a predicted operational efficiency value of the system that is based at least in part on at least some of the number of predicted values;
receiving another input comprising a number of actual values for at least some of the number of operational parameters;
calculating an actual operational efficiency value of the system that is based at least in part on at least a portion of the another input; and
making a comparison between a pre-established tolerance value and a difference between the predicted operational efficiency value and the actual operational efficiency value.

2. The notification apparatus of claim 1 wherein the system is one that is periodically idle, and wherein the operations further comprise:
determining from the comparison that the difference is within the tolerance; and
instructing the performance of a diagnostic operation on the system during an idle period of the system.

3. The notification apparatus of claim 2 wherein the operations further comprise performing as at least a portion of the diagnostic operation:
generating an output that performs on the system an operation that is representative of a predetermined change in at least a first environmental parameter of the number of environmental parameters; and
detecting one or more actual values for at least some of the number of operational parameters that reflect the effect on the system of the predetermined change in the at least first environmental parameter.

4. The notification apparatus of claim 3 wherein the predetermined change in the at least first environmental parameter comprises a time-varying change in the at least first environmental parameter.

5. The notification apparatus of claim 3 wherein the operations further comprise calculating an experimental operational efficiency value of the system that is based at least in part upon at least a portion of the one or more actual values.

6. The notification apparatus of claim 1 wherein the system is one that is periodically idle, and wherein the operations further comprise:
determining from the comparison that the difference is one of within the tolerance and outside the tolerance;
instructing the performance of a relatively less extensive diagnostic operation on the system during an idle period of the system when the difference is within the tolerance; and
instructing the performance of a relatively more extensive diagnostic operation on the system when the difference is outside the tolerance.

7. The notification apparatus of claim 1 wherein the operations further comprise:
determining from the comparison that the difference is outside the tolerance;
inputting at least a portion of at least one of the number of predicted values and the number of actual values to a rule-based diagnostic routine that comprises a number of rules wherein a particular diagnosis results from at least one of a predicted value from among the number of predicted values and an actual value from among the number of actual values being of a predetermined magnitude; and
outputting from the rule-based diagnostic routine at least a first diagnosis that is based at least in part upon the at least portion of at least one of the number of predicted values and the number of actual values.

8. The notification apparatus of claim 1 wherein the number of environmental parameters comprise at least one of a temperature and a pressure, and wherein the operations further comprise:
calculating as the predicted operational efficiency value a predicted cooling efficiency of the system; and
calculating as the actual operational efficiency value an actual cooling efficiency of the system.

9. A notification apparatus usable with an operable system, the system in operation having a number of operational parameters whose values vary, the notification apparatus comprising:
a processor apparatus comprising a processor and a storage;
an input apparatus structured to provide input signals to the processor apparatus;
an output apparatus structured to receive output signals from the processor apparatus;
the storage having stored therein a number of routines that include a rule-based diagnostic routine which, when executed on the processor, causes the notification apparatus to perform operations comprising:
receiving an input comprising a number of values for at least some of the number of operational parameters;
inputting at least a portion the input to the rule-based diagnostic routine which has a number of rules wherein a particular diagnosis results from at least one value from among the number of values being of a predetermined magnitude; and
outputting from the rule-based diagnostic routine at least a first diagnosis that is based at least in part upon the at least portion of at least one of the number of predicted values and the number of actual values.

10. The notification apparatus of claim 9 wherein the number of operational parameters comprise at least a first pressure.

11. The notification apparatus of claim 9 wherein the number of operational parameters consist of a first pressure and a second pressure.
